(19) United States
(12) Patent Application Publication
(10) Pub. No.: US 2011/0163250 A1
(43) Pub. Date: Jul. 7, 2011

(54) DISK ACTUATOR FOR A PROPANE CARBURETOR

(76) Inventor: Clifford D. Feldmann, St. Cloud, FL (US)

(21) Appl. No.: 12/983,795

(22) Filed: Jan. 3, 2011

Related U.S. Application Data
(60) Provisional application No. 61/291,991, filed on Jan. 4, 2010.

(51) Int. Cl. F16K 31/44

(52) U.S. Cl. 251/213

(57) ABSTRACT

One example embodiment includes a disk actuator. The disk actuator includes a disk and a shaft, where the shaft is connected to the disk such that rotation of the disk causes rotation of the shaft. The disk actuator also includes a plug, where the plug is connected to the shaft such that rotation of the shaft causes rotation of the plug. The plug includes a channel, wherein the channel is configured to regulate the flow of air into a carburetor.

### CROSS-REFERENCE TO RELATED APPLICATIONS

This application claims the benefit of and priority to U.S. Provisional Patent Application Ser. No. 61/291,991 filed on Jan. 4, 2010, which application is incorporated herein by reference in its entirety.

### BACKGROUND OF THE INVENTION

Gasoline carburetors have been used extensively in internal combustion engines. Small engines and large engines have both been designed with carburetors to provide the fuel and air mixture needed to power the engine. In particular, the engine pulls in a fuel and air mixture from the carburetor where it is combusted, producing mechanical power. The carburetor, in turn, pulls in fuel and air in the correct ratio and mixes them. Small engines, in particular, benefit from the relative simplicity of the carburetor and the mechanical reliability of the carburetor over long periods of time.

Gasoline, as a fuel, however, has a number of drawbacks. For example, gasoline engines, especially small engines, may need to be primed and properly choked to allow the engine to start. Over priming of the engine can flood the engine. Once the engine has been flooded, the operator must generally wait for a period of time for the excess gasoline to evaporate from the combustion chamber before attempting to once again start the engine.

In addition, gasoline does not work well as a fuel at colder temperatures. In particular, in colder applications engines often will not start on their own. Instead the engine must be heated before starting or else the gasoline will not ignite. I.e., the operator must turn on a heater, either electric or using some other fuel source, which heats the engine for a time before turning on the engine. This can lead to unacceptable delays.

Further, gasoline produces a high amount of carbon dioxide emissions. Carbon dioxide is considered by some to be a greenhouse gas, the excess production of which is implicated in global warming. In addition, gasoline can contain a number of other pollutants, such as sulfur, carbon monoxide, nitrogen oxides and hydrocarbons, which can be released into the atmosphere when the gasoline is combusted. The production of these pollutants has become highly regulated by a number of governments because of their adverse environmental effects.

Moreover, gasoline makes for difficult throttle control. That is, slight changes in the throttling of gasoline engines can make for large changes in the power produced in the engine. Additionally, the ratio of gasoline to air is quite sensitive, making precise throttling adjustments with gasoline engines difficult. This is particularly true at lower temperatures. The ratio of gasoline to air needs to be higher at lower temperature and lower at higher at lower temperatures, making the engine difficult to control at times, especially in cold weather applications. This can be especially troublesome when precise engine control is required.

Finally, gasoline which is spilled can contaminate the immediate area. The gasoline can evaporate into the atmosphere where it is a pollutant. Alternatively, the gasoline can foul other equipment. For example, in ice fishing a drill is used to drill through the ice to reach water. If the ice fisherman spills gasoline or gets it on his hands or otherwise spreads it such that the gasoline gets on the fishing equipment, the equipment is fouled and cannot be used until the equipment is cleaned.

There are other fuels available for engines. For example, natural gas, propane and other volatile hydrocarbons are readily available. Because they are gases when not stored under pressure the chances of contamination are much lower. Additionally, engines using volatile hydrocarbons do not need to be primed, as the fuel naturally and quickly diffuses to the combustion chamber. Further, the operating temperature ranges of these fuels are much larger and the throttle control may be much better. However, standard carburetors are poorly suited for propane engines and engines which use other volatile hydrocarbons. The ratio of fuel to air in these engines can vary dramatically from the ratio used in a gasoline engine.

Accordingly, there is a need in the art for a carburetor which works with non-gasoline engines. Further, there is a need in the art for the carburetor to provide accurate throttle control for the engine, even at lower temperatures. In addition, there is a need in the art for a carburetor which works with fuels that are unlikely to contaminate other equipment.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a disk actuator. The disk actuator includes a disk and a shaft, where the shaft is connected to the disk such that rotation of the disk causes rotation of the shaft. The disk actuator also includes a plug, where the plug is connected to the shaft such that rotation of the shaft causes rotation of the plug. The plug includes a channel, wherein the channel is configured to regulate the flow of air into a carburetor.

Another example embodiment includes a disk actuator. The disk actuator includes a disk and a shaft, where the shaft is connected to the disk such that rotation of the disk causes rotation of the shaft. The disk actuator also includes a plug, where the plug is connected to the shaft such that rotation of the shaft causes rotation of the plug. The plug includes a channel, wherein the channel is configured to regulate the flow of air into a carburetor. The plug further includes a needle valve, where the needle valve is configured to regulate the ratio of fuel entering the carburetor in relation to the amount of air entering the carburetor.

Another example embodiment includes a propane carburetor. The propane carburetor includes a propane intake, where the propane intake allows propane to enter the carburetor, and an air intake, where the air intake allows air to enter the carburetor. The propane carburetor also includes a mixing chamber, where the propane entering the carburetor through the propane intake and the air entering the carburetor through the air intake are mixed in the mixing chamber. The propane carburetor further includes a disk actuator. The disk actuator includes a disk and a shaft, where the shaft is connected to the disk such that rotation of the disk causes rotation of the shaft. The disk actuator also includes a plug, where the plug is connected to the shaft such that rotation of the shaft causes rotation of the plug. The plug includes a channel, wherein the channel is configured to regulate the flow of air into the mixing chamber. The plug further includes a needle valve, where the needle valve is configured to regulate the ratio of fuel entering the carburetor in relation to the amount of air entering the carburetor.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of a propane carburetor;

FIG. 1B illustrates a perspective view of the propane carburetor;

FIG. 2 illustrates a cut away view of the propane carburetor;

FIG. 3A illustrates a side view of the disk actuator in idle position;

FIG. 3B illustrates a perspective view of the disk actuator in idle position;

FIG. 4A illustrates a side view of the disk actuator at full throttle; and

FIG. 4B illustrates a perspective view of the disk actuator at full throttle.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

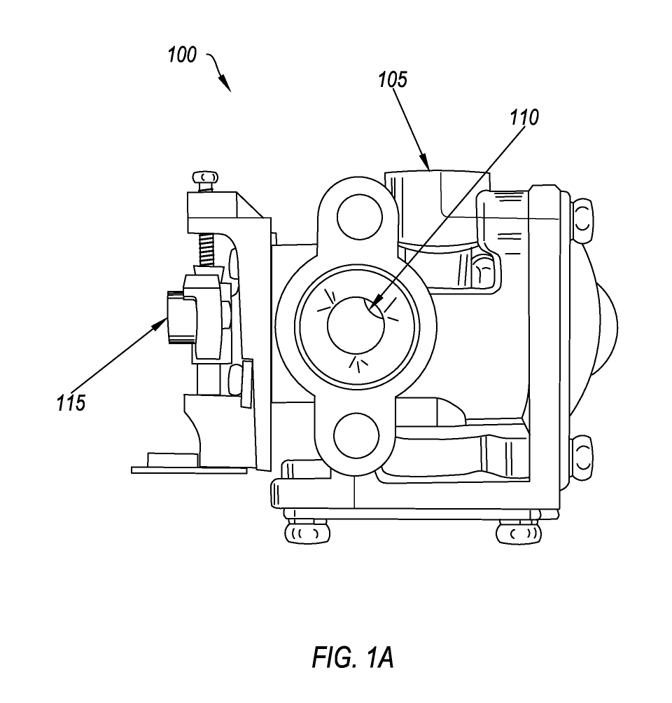

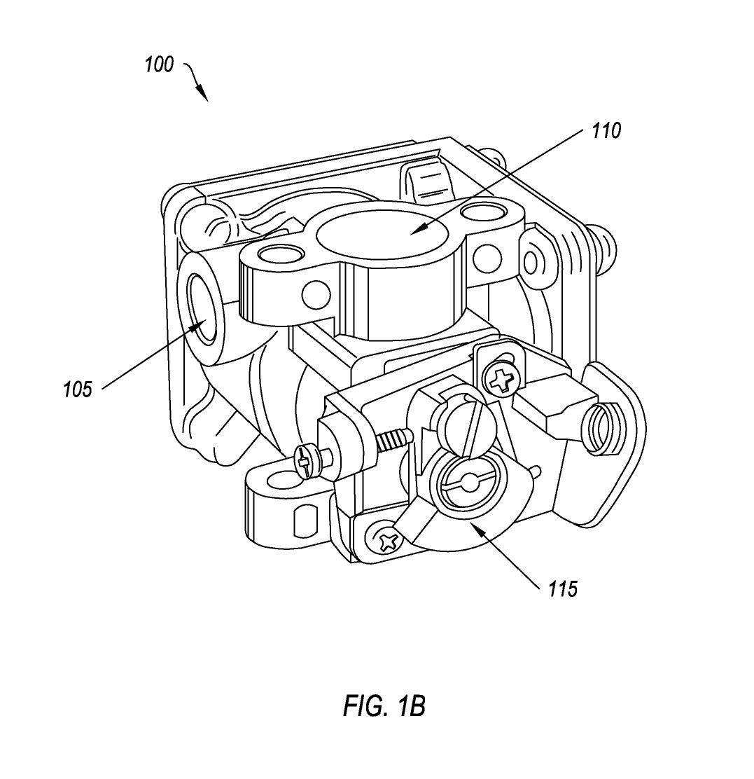

FIGS. 1A and 1B illustrate an example of a propane carburetor 100. FIG. 1A illustrates a side view of the propane carburetor 100; and FIG. 1B illustrates a perspective view of the propane carburetor 100. In at least one implementation, the propane carburetor 100 (also carburettor or carburetter) is a device that blends air and propane for an internal combustion engine. In particular, the propane carburetor 100 mixes propane and air in a predetermined ratio and allows the mixture to flow into an internal combustion engine where it can be converted into mechanical energy. One of skill in the art will appreciate that although propane is treated as exemplary herein, the propane carburetor and any other parts in the specification and the claims can be used with other fuel types, such as other volatile hydrocarbons, unless otherwise specified.

In at least one implementation, propane can offer a number of benefits over other fuels. In particular, the engine can be started without priming, choking or the risk of flooding. Additionally or alternatively, propane has a wide operating range. In particular, propane remains an effective fuel between temperatures of −25 degrees Celsius or lower and 35 degrees Celsius. Further, propane produces fewer emissions than other fuels and does not leave contaminants if spilled.

FIGS. 1A and 1B show that the propane carburetor 100 can include a propane intake 105. In at least one implementation, the propane intake 105 allows propane to enter the propane carburetor 100. The propane will enter a mixing chamber within the propane carburetor 100. The flow of propane does not need to be forced or pumped, as the flow of air in the mixing chamber and the vapor pressure of the propane will create a pressure gradient which causes the correct amount of propane into the mixing chamber, as discussed below.

FIGS. 1A and 1B also show that the propane carburetor 100 can include an air intake 110. In at least one implementation, the air intake 110 allows air to enter the propane carburetor 100. One of skill in the art will appreciate that air can refer to any gas mixture which, when mixed with the propane, will allow the propane to undergo combustion. For example, the air can include air from the atmosphere of some other gas which includes oxygen for propane combustion.

In at least one implementation, the propane carburetor 100 can include an outlet. The outlet can allow the mixed propane and air to exit the mixing chamber. I.e., the outlet provides the propane and air mixture to the combustion chamber in an engine, where a spark is introduced and the propane is combusted and mechanical energy is produced. In particular, the outlet can be connected to the mixing chamber and the combustion chamber, such that the propane and air mixture can be drawn into the combustion chamber as needed for the engine to produce the required power.

FIGS. 1A and 1B further show that the propane carburetor 100 can include a disk actuator 115. In at least one implementation, the disk actuator 115 can control the flow of propane and air into the mixing chamber. In particular, the disk actuator 115 can control the air flow into the mixing chamber which, in turn, controls the propane flow into the mixing chamber, as described below. I.e. the disk actuator 115 can be connected to the throttle or throttle cable, allowing the operator to control the power output of the engine.

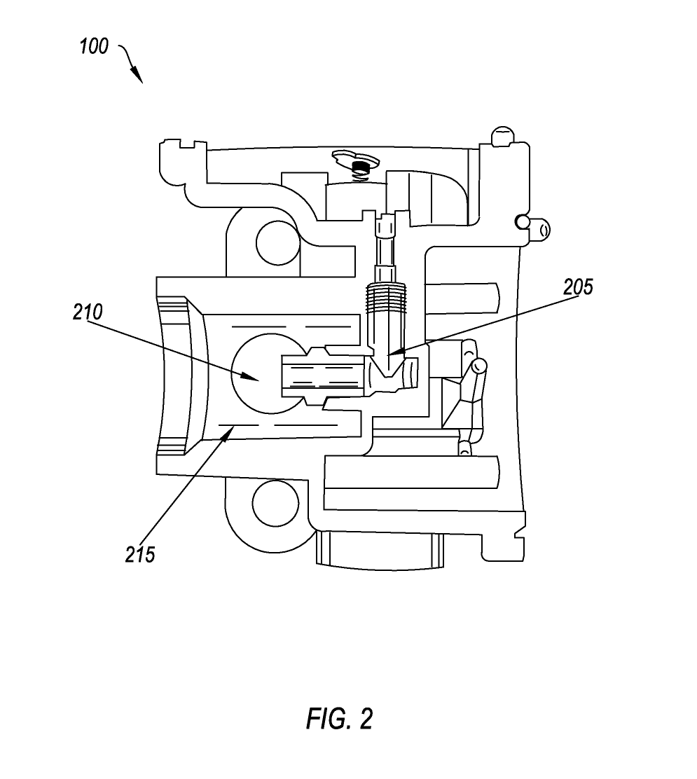

FIG. 2 illustrates a cut away view of the propane carburetor 100. The cut-away view can be used to illustrate the propane flow through the propane carburetor 100. The propane carburetor 100 can be used to mix propane and air to be supplied to the combustion chamber, as described above. In particular, the propane carburetor 100 can be configured to work effectively with propane, a fuel that most carburetors are unsuitable for mixing in the proper ratio with air.

FIG. 2 shows that the propane carburetor 100 can include a passage 205. In at least one implementation, propane can enter the propane carburetor 100 through the passage 205. The flow rate of propane through the passage 205 can be controlled by the flow of air through the propane carburetor 100, as described below. Additionally, a needle valve can be used to control the amount of propane flowing through the passage 205, as described below. I.e., the propane can be pulled through the passage 205 at a variable rate which depends on the air flow and the position of a needle valve which provides the proper propane to air ratio based on its position and the position of the throttle.

FIG. 2 also shows that the propane carburetor 100 can include a venturi 210. In at least one implementation, the venturi 210 includes a constricted section of a pipe, shaft or other system through which a fluid, such as a liquid or gas, is flowing. The constriction results in a reduction in fluid pressure. According to the laws governing fluid dynamics, a fluid's velocity must increase as it passes through a constriction to satisfy the conservation of mass, while its pressure must decrease to satisfy the conservation of energy. Thus any gain in kinetic energy a fluid may accrue due to its increased velocity through a constriction is negated by a drop in pressure. This reduction in pressure in the venturi 210 pulls the propane through the passage 205 in the required amounts.

FIG. 2 further shows that the passage 205 and the venturi 210 can meet to form a mixing chamber 215. In at least one implementation, the pressure of the air entering the mixing chamber 215 through the venturi 210 is lower than ambient pressure. I.e., the air that enters the air intake is at ambient pressure, as the air passes through the venturi 210 the flow rate of the air is increased, but the pressure of the air is decreased. This decrease in air pressure results in a pressure imbalance within the passage 205. I.e., the propane intake pressure is higher than the pressure of the mixing chamber 215. This pressure imbalance forces the propane through the passage 205 into the mixing chamber 215.

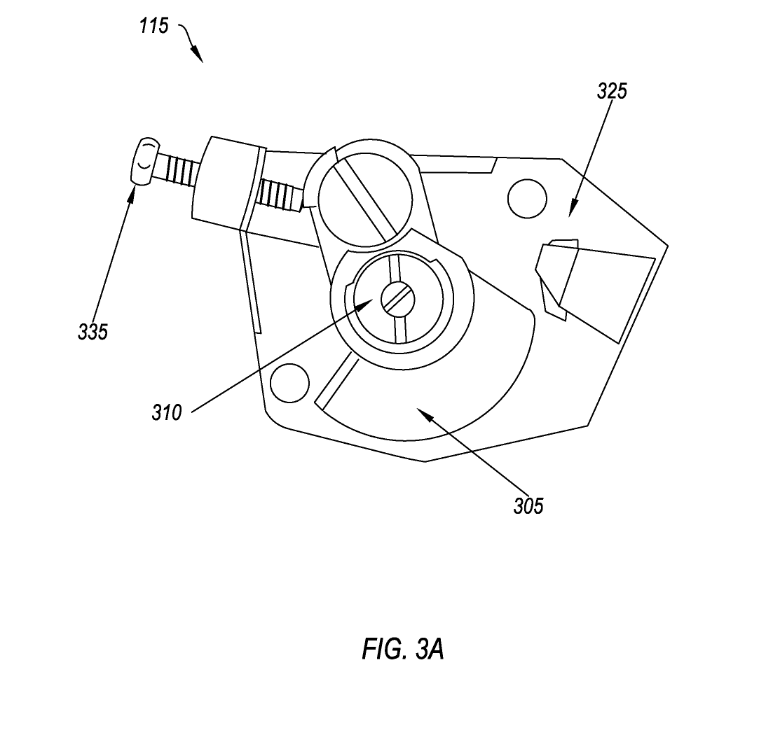

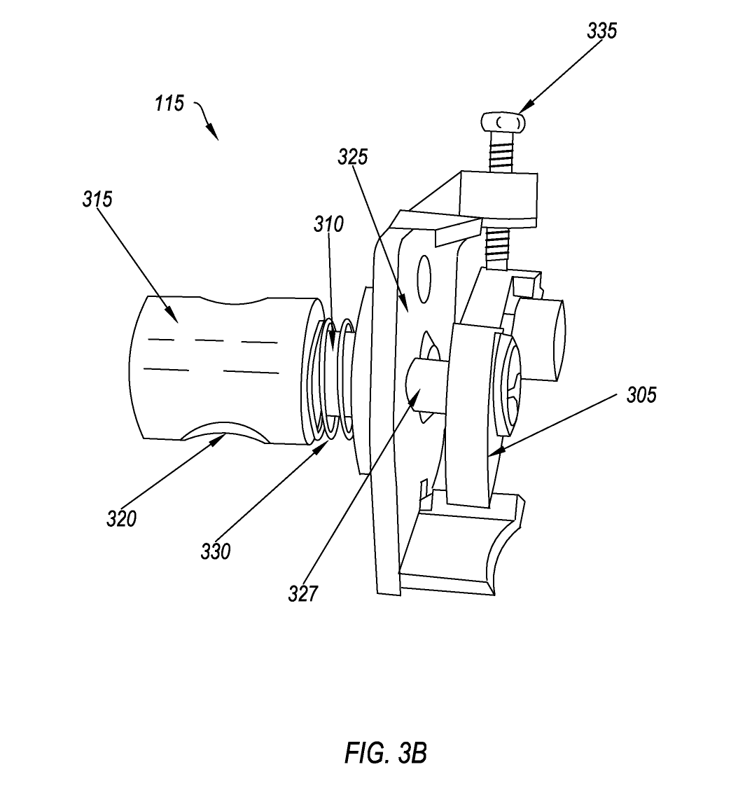

FIGS. 3A and 3B illustrate an example of a disk actuator 115 in idle position. FIG. 3A illustrates a side view of the disk actuator 115; and FIG. 3B illustrates a perspective view of the disk actuator 115. In at least one implementation, the disk actuator 115 is configured to control the flow of air and propane entering a propane carburetor, as described above. In particular, the disk actuator can be connected to a throttle controlled by an operator. The throttle can allow the operator to control the amount of propane and air entering a propane carburetor, which, in turn, controls the amount of power produced by the engine.

FIGS. 3A and 3B show that the disk actuator 115 can include a disk 305. One of skill in the art will appreciate that the disk need not be circular in shape. I.e., the disk 305 can include a disk or cylinder having an irregular form. That is, disk 305 can be shaped such that the diameter varies in different directions from the center of the disk 305. The varying diameter can allow for a nonrotational force to be applied to a particular portion of the disk 305 to be translated to rotational force. I.e., the disk 305 can include a portion that can translate linear motion over a short range into rotational motion.

FIGS. 3A and 3B also show that the disk actuator 115 can include a shaft 310. In at least one implementation, the disk 305 is attached to the shaft 310. Attaching the disk 305 to the shaft 310 can allow the rotational motion induced in the disk 305 to be transferred to the shaft 310. That is, if force is applied to the disk 305, the force is translated into rotational force of the disk 305, which, in turn, rotates the shaft 310. Rotation of the shaft 310 can allow more air to enter the propane carburetor, as described below. In particular, the rotation of the shaft 310 can transfer the force to the interior mechanisms of the disk actuator 115.

FIGS. 3A and 3B further show that the disk actuator 115 can include a plug 315. In at least one implementation, the plug 315 is configured to reside in a mixing chamber of a propane carburetor, such as the mixing chamber 215 shown if FIG. 2. The plug 315 can control the air flow through the mixing chamber which, in turn, can control the flow rate of the propane into the mixing chamber, as described above. For example, the plug 315 can rotate within the mixing chamber, allowing more or less air and propane to enter the mixing chamber, as desired by the operator.

FIGS. 3A and 3B show that the plug 315 can include a channel 320. In at least one implementation, the channel 320 can be aligned with the air intake and outlet of a propane carburetor, such as the air intake 110 and the outlet of FIGS. 1A and 1B. The amount of alignment can be used to control the air flow. In particular, if the channel 320 is not aligned with the air intake, no air can flow into the mixing chamber and the engine is, therefore, inoperable. However, if the channel 320 is aligned with the air intake to a low degree, only a small amount of air and propane can flow into the mixing chamber and the engine will produce little power. For example, the engine may be idling or at a very low throttle position. In contrast, if the channel 320 is aligned to a high degree with the air intake, then a high amount of air and propane will flow into the mixing chamber and the engine will produce a relatively higher amount of power.

One of skill in the art will appreciate that a force on the disk 305 can be used to align the channel 320 with the air intake. In particular, a throttle can be connected to the disk 305. Force on the throttle can be transferred to the disk 305 which will rotate the shaft 310. This will, in turn rotate the plug and adjust the alignment between the channel 320 with the air intake, which adjusts the amount of air and propane introduced into the combustion chamber. Thus, the operator can adjust the amount of power by adjusting the throttle.

FIGS. 3A and 3B further show that the disk actuator 115 can include a base 325. In at least one implementation, the base 325 can surround the shaft 310. The base 325 can include a guide 327 which is pushes the disk 305 away from the base 325 when the disk 305 is rotated, as described below. Additionally or alternatively, the base 325 can include a projection and the plug 315 can be mounted on the projection of the base 325. The interface between the plug 315 and the base 325 can include a threading. The threading can include a helical structure used to convert between rotational and linear movement or force. The conversion of force by the threading can bias the engine toward an idling position, as described below.

FIGS. 3A and 3B further show that the disk actuator 120 can include a compressed spring 330. In at least one implementation, the compressed spring 330 is configured to push the plug 315 away from the base 325 along the shaft 310. That is, unless there is a force which overcomes the force provided by the compressed spring 330, the compressed spring 330 will push the plug 315 away from the base 325 until rotational or linear motion of the plug 315 is prevented. For example, the movement of the plug 315 away from the base 325 can be prevented by the guide 327 or by a threaded interface between the plug 315 and the base 325. Thus, the spring 330 biases the channel 320 in a particular alignment relative to the air intake.

FIGS. 3A and 3B also show that the disk actuator 115 can include an idle screw 335. In at least one implementation, the idle screw 335 can allow a small amount of air and propane to enter the mixing chamber. In particular, the idle screw 335 prevents the disk 305 from rotating counter-clockwise, as shown in FIG. 3A, keeping a low level of alignment between the channel 320 and the air intake. This allows a small amount of air and propane to continue to enter the mixing chamber and pass into the combustion chamber.

In at least one implementation, the idle screw 335 can be configured to adjust the base alignment of the channel 320 relative to the air intake. In particular, as the idle screw 335 is screwed in, the alignment between the channel 320 and the air intake can be increase. Thus, the amount of air and propane entering the mixing chamber, and therefore the combustion chamber, is increased. In contrast, as the idle screw 335 is screwed out, the alignment between the channel 320 and the air intake can be decreased. Thus, the amount of air and propane entering the mixing chamber, and therefore the combustion chamber, is decreased.

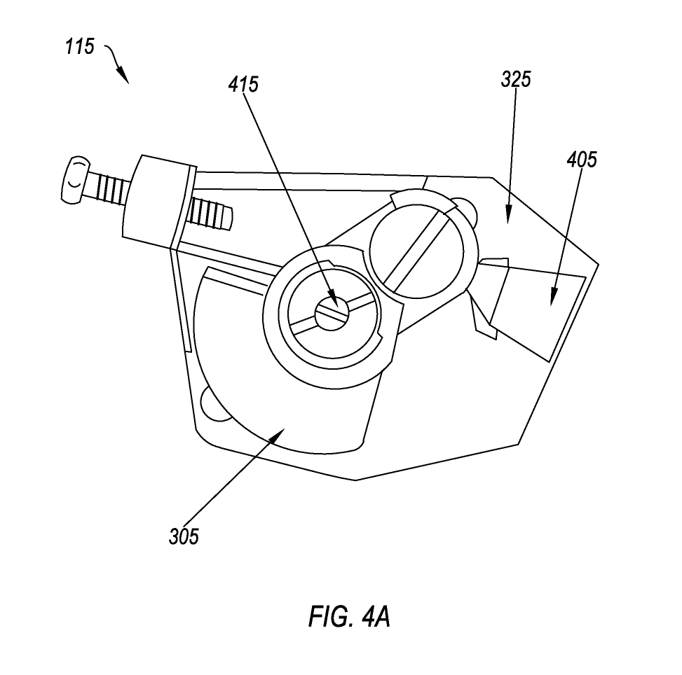

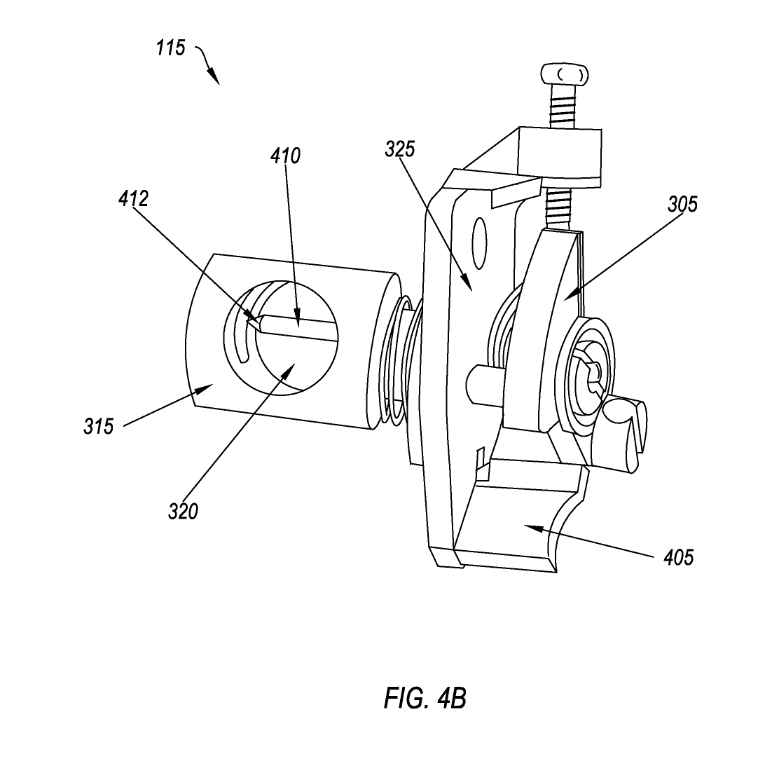

FIGS. 4A and 4B illustrate and example of a disk actuator 115 at full throttle. FIG. 4A illustrates a side view of the disk actuator 115; and FIG. 4B illustrates a perspective view of the disk actuator 115. In at least one implementation, the disk actuator 115 at full throttle is configured to supply the maximum amount of air and propane to the engine. I.e., the disk actuator at full throttle allows the engine to produce the maximum amount of power.

FIGS. 4A and 4B show that the disk 305 is rotated relative to the position of the disk 305 as shown in FIGS. 3A and 3B. In at least one implementation, the throttle can be configured to position the disk in any position between the positions shown in FIGS. 3A and 3B and the positions shown in FIGS. 4A and 4B. Additionally or alternatively, the throttle can be configured to position the disk only in the position shown in FIGS. 4A and 4B when force is applied to the throttle. This rotation of the disk 305, in turn, changes the orientation and position of the plug 315 relative to the propane carburetor.

FIGS. 4A and 4B further show that the disk actuator 115 can include a stop 405. In at least one implementation, the stop 405 is configured to stop the disk 305 as it rotates clockwise, as shown in FIG. 4A. I.e., the disk 305 is not allowed to rotate completely about the shaft. As the disk 305 stops rotating the channel 320 and the air intake are fully aligned. That is, the maximum amount of air and propane enter the mixing chamber and, therefore, the combustion chamber, producing the maximum amount of power output from the engine.

FIGS. 4A and 4B also show that the disk actuator 115 can include a needle-shaped plunger 410. In at least one implementation, the needle-shaped plunger 410 works in conjunction with a valve seat to form a needle valve. In particular, the needle-shaped plunger 410 can include a tapered end 412 which can be inserted into the valve seat, such as the end of the passage 205 of FIG. 2, in order to form a needle valve which controls the amount of propane flowing into the mixing chamber. The distance between the needle-shaped plunger 410 and the valve seat can control the amount of propane flowing into the mixing chamber. I.e., adjusting the needle-shaped plunger 410 can adjust the propane to air ratio, as described below.

In at least one implementation, the rotation of the disk 305 adjusts the position of the needle-shaped plunger 410 relative to the valve seat. In particular, as the disk 305 is rotated toward the stop 405, the needle-shaped plunger 410 moves toward the base 325. This movement, in turn, further separates the needle-shaped plunger 410 and the valve seat, increasing the amount of propane entering the mixing chamber and, therefore, the combustion chamber.

FIGS. 4A and 4B further show that the needle-shaped plunger 410 includes a head 415. A screwdriver or other tool can be inserted into the head 415 in order to change the alignment of the needle-shaped plunger 410 relative to the valve seat. In particular, as the head 415 is turned counter-clockwise and the needle-shaped plunger 410 is retracted, the distance between the valve seat and the plunger is increased; however, the needle-shaped plunger 410 continues to impede the flow somewhat. Thus, as the head is further turned, the flow of propane increases. Since it can take many turns of the head 415 to retract the plunger, precise regulation of the flow rate is possible. In contrast, as the head 415 is turned clockwise the needle-shaped plunger 410 is moved toward the valve seat, and the flow of propane is reduced. One of skill in the art will understand that the threading of the needle-shaped plunger 410 can be left-handed rather than right-handed; therefore turning the head 415 counter-clockwise can impede the flow of propane while turning the head 415 clockwise can increase the flow rate of the propane.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A disk actuator, the disk actuator comprising:
a disk;
a shaft, wherein the shaft is connected to the disk such that rotation of the disk causes rotation of the shaft; and
a plug, wherein the plug is connected to the shaft such that rotation of the shaft causes rotation of the plug and wherein the plug includes:
a channel, wherein the channel is configured to regulate the flow of air into a carburetor.

2. The disk actuator of claim 1 further comprising a base, wherein the plug is capable of rotating relative to the base.

3. The disk actuator of claim 2 further comprising a threading at the interface between the plug and the base.

4. The disk actuator of claim 3 further comprising a compressed spring wherein the compressed spring is configured to keep the plug in its furthest position from the base absent an external force.

5. The disk actuator of claim 1 further comprising a stop, wherein the stop is configured to stop the rotation of the disk at a position of maximum air flow through the channel.

6. The disk actuator of claim 1 further comprising an idle screw.

7. The disk actuator of claim 1 further comprising a needle-shaped plunger.

8. The disk actuator of claim 7, wherein the needle-shaped plunger is located within the interior of the plug.

9. The disk actuator of claim 7, wherein the needle-shaped plunger is configured to regulate the flow of propane into a mixing chamber of the carburetor.

10. The disk actuator of claim 7, wherein the needle-shaped plunger includes a threaded portion, wherein the threaded portion is configured to allow the position of the needle-shaped plunger relative to the plug.

11. A carburetor including the disk actuator of claim 1.

12. A disk actuator, the disk actuator comprising:
a disk;
a shaft, wherein the shaft is connected to the disk such that rotation of the disk causes rotation of the shaft; and
a plug, wherein the plug is connected to the shaft such that rotation of the shaft causes rotation of the plug and wherein the plug includes:
a channel, wherein the channel is configured to regulate the flow of air into a carburetor; and
a needle valve, wherein the needle valve is configured to regulate the ratio of fuel entering the carburetor in relation to the amount of air entering a mixing chamber of the carburetor.

13. The disk actuator of claim 12, wherein at least a portion of the needle valve is located within the interior of the plug.

14. A carburetor including the disk actuator of claim 12.

15. A propane carburetor, the propane carburetor comprising:
a propane intake, wherein the propane intake allows propane to enter the carburetor;
an air intake, wherein the air intake allows air to enter the carburetor;
a mixing chamber, wherein the propane entering the carburetor through the propane intake and the air entering the carburetor through the air intake are mixed in the mixing chamber;
a disk actuator, wherein the disk actuator includes:
a disk;
a shaft, wherein the shaft is connected to the disk such that rotation of the disk causes rotation of the shaft; and
a plug, wherein rotation of the shaft causes rotation of the plug and wherein the plug includes:
a channel, wherein the channel is configured to regulate the flow of air into the mixing chamber; and
a needle valve, wherein the needle valve is configured to regulate the ratio of propane entering the mixing chamber in relation to the amount of air entering the mixing chamber.

16. The disk actuator of claim 15, wherein the air intake include a venturi.

17. The disk actuator of claim 16, wherein the venturi has a smaller diameter than the opening of the air intake.

18. The disk actuator of claim 15, wherein the needle valve includes a needle-shaped plunger.

19. The disk actuator of claim 18, wherein the needle-shaped plunger includes a tapered end.

20. The disk actuator of claim 19, wherein the tapered end is inserted into a valve seat, wherein the valve seat is connected to the propane intake.
